(19) United States
(12) Patent Application Publication
(10) Pub. No.: US 2008/0000833 A1
(43) Pub. Date: Jan. 3, 2008

(54) Microstructured separating device and microfluidic process for separating liquid components from a particle-containing liquid

(76) Inventors: Ralf-Peter Peters, Bergisch-Gladbach (DE); Gert Blankenstein, Dortmund (DE)

Correspondence Address: Christopher J. McDonald;HOFFMAN, WASSON & GITLER, P.C., Suite 522, 2461 South Clark Street, Arlington, VA, 22202, US

(21) Appl. No.: 11/812,290

(22) Filed: Jun. 18, 2007

Related U.S. Application Data
(63) Continuation-in-part of application No. 10/804,220, filed on Mar. 19, 2004, now abandoned.

(30) Foreign Application Priority Data
Mar. 21, 2003 (DE) 103 13 201.5

(51) Int. Cl. B01D 35/28; B01D 29/88; C02F 1/44

(52) U.S. Cl. 210/634; 210/456

(57) ABSTRACT

A microstructured separating device, especially for separating liquid components from a particle-containing liquid, comprising the following features: at least one transport channel for transport of the liquid in a given transport direction; at least one separating area at a branch point of the transport channel which is adjoined by a side channel through which a partial flow of the liquid from the transport channel is diverted; a microstructure in the separating area which keeps larger particles of the liquid out of the separating area and which slows down the transport of smaller particles in the separating area.

### CROSS REFERENCE TO RELATED APPLICATIONS

This application is a continuation-in-part application of U.S. patent application Ser. No. 10/804,220, filed Mar. 19, 2004.

### BACKGROUND OF THE INVENTION

This invention relates to a microstructured separating device and microfluidic process for separating liquid components from a particle-containing liquid.

Such a device is used, for example, to isolate blood plasma from the cellular components contained in the blood (hematocrit). Human blood is composed on the one hand of a liquid blood plasma which comprises roughly 55% of the human blood, and on the other hand of cellular components, the hematocrit, which comprise roughly 45% of the human blood. The blood plasma is a yellowish, aqueous solution of proteins, carbohydrates, lipids and mineral salts which also contains antibodies. The blood plasma consists 90% of water and 10% of substances dissolved in it. The hematocrit consists among others of red blood cells (erythrocytes) and white blood cells (leukocytes). The red blood cells are the smaller particles in the blood. The are made disk-shaped, having a diameter of roughly 7.7 microns and a height of roughly 2 microns, and being easily deformable. Conversely the white blood cells are larger and they therefore form the larger particles in the blood, with a size from 7 to 20 microns. Moreover the white blood cells compared to the red blood cells cannot be deformed or can only be deformed a little.

For many medical studies it is necessary for the blood plasma to be isolated from the hematocrit contained in the blood in order to be able to study the blood plasma. Currently several devices and processes are known for isolating blood plasma from blood or for isolating the liquid components of a liquid which contains larger and smaller particles.

One known process for isolating blood plasma from blood is sedimentation. To do this a vessel is filled with chemically treated blood and the blood is stored in the vessel until the cellular components of the blood settle on the bottom of the vessel and the yellowish-clear blood plasma remains as the supernatant. The blood plasma can be skimmed off for example using a pipette. For sedimentation, a relatively long time is necessary until the blood plasma can be obtained.

In another process for isolation of blood plasma from blood a laboratory centrifuge is used. The blood is placed in the laboratory centrifuge, and the blood plasma and the particles in the blood are separated from one another as a result of centrifugal forces. For this process a complex laboratory centrifuge is necessary. Both sedimentation and also isolation by means of a laboratory centrifuge are suitable only for relatively large volumes of blood.

Another process is filtering of blood by means of a mechanical filter with an open-pore filter medium with passage openings which are dimensioned such that all particles of the blood are retained. Thus neither the white blood cells nor the red blood cells can pass through the filter. The blood is delivered to the filter, the particles being retained by the filter, while the blood plasma penetrates into the filter medium and seeps through the filter medium as soon as the filter medium is completely loaded with blood plasma. The capacity of these filters is limited, since a filter cake builds up on the filter and clogs the filter. These filters have already been implemented as microstructures, the same problems occurring with respect to capacity and clogging of the filter as in larger filters. The separated plasma which is contained in the filter medium can be examined without its being retrieved from the filter medium, or it can be retrieved from the filter medium by additional manipulation. If only a small amount of blood is available, this process is tedious.

Furthermore a process which uses the Zweifach-Fung effect is known for isolation of blood plasma from blood. In the Zweifach-Fung device blood is transported by means of a pump through a channel, the transport channel having a branch point. The branch point or the channels which continue out of the branch point are designed such that the one of the continuing channels holds a much larger proportion of the volumetric flow of the supplied blood than the other channel. As a result of the Zweifach-Fung effect, in the channel in which the larger volumetric flow of blood is transported a much larger proportion of the particles contained in the blood is transported than in the other channel. By cascading these branch points in the channel with the volumetric flow which is smaller at the time the plasma can be isolated from the particles of the blood in this way. Such a device requires on the one hand a complex structure with cascaded branch points, and on the other hand a pump to produce the necessary volumetric flow in the transport channels. Moreover a relatively large amount of liquid is necessary for a sufficient quantity of the liquid components to be isolated. Channels in which the Zweifach-Fung effect occurs are larger than 10 microns in both directions transversely to the direction of flow; they can for example be 25 microns deep and 50 microns wide.

An object of the invention is to propose a device and a process in which liquid components from a liquid are separated from the particles contained in the liquid without a filter medium and without a pump or other auxiliary device. The device and the process should be suitable especially for a supplied amount of liquid in the range of a few microliters.

### SUMMARY OF THE INVENTION

An object is achieved by a microstructured separating device 1 and by a microfluidic process. The device has a transport channel for transport of the supplied, particle-containing liquid and at least one separating area for separation of part of the liquid, the separated partial amount being free of particles or containing only few particles. The separating area has a microstructure which is made such that it retains the larger particles and slows down the smaller particles in the separating area.

In a first version of the device, the transport channel for the particle-containing liquid can be a channel through which an unlimited amount of the particle-containing liquid can flow. Furthermore, the transport can be provided with an inlet and an outlet for the particle-containing liquid. In this version a limited amount of the particle-containing liquid is fed into the inlet. The separating area can be located at a branch point of the transport channel. The particle-containing liquid is routed past the input of the separating area, and a partial amount of the liquid is diverted as a side stream. The separating area can be adjoined by a collecting space for the separated partial amount of liquid, which space is provided with a vent opening. Furthermore the separating area can be provided with a diversion channel for the separated partial amount of liquid.

In a second version of the device, the separating area can be located on the end of the transport channel which is provided with an inlet. In this version the particle-containing liquid is supplied directly to the separating area and a partial amount of the liquid is relayed via the separating area. The separating area can be adjoined by a collecting space for the separated partial amount of liquid, which space is provided with a vent opening. Furthermore the separating area can be provided with a diversion channel for the separated partial amount of liquid. In this version the transport channel, the separating area and the collecting space are located in succession.

The device has several advantages over the devices known from the existing art. On the one hand, the liquid can be transported in the transport channel without a pump. For transport of the liquid in the transport channel capillary forces are sufficient. Another advantage is that the separating area is located next to the transport channel. By the liquid flowing in the transport channel the particles of the liquid which do not penetrate into the separating area can be washed away from the liquid flow in the transport channel. A “filter cake” does not form in front of the separating area.

The liquid entering the separating area can contain only the smaller particles. They are slowed down in their transport speed upon entry into the separating area or within the separating area relative to the liquid components of the liquid. The liquid components of the liquid are transported more rapidly through the separating area than the smaller particles. In this way only the liquid components of the liquid reach the end of the separating area over a longer time interval. During this time interval a quantity of the liquid components which is sufficient for the desired analyses is transported through the separating area.

The smaller particles are slowed down when they enter the separating area or within the separating area by the microstructure and by surface effects, for example by the “chromatographic effect”. Due to the “chromatographic effect”, in a channel of uniform shape the liquid components of a liquid can be transported more rapidly than the particles contained in it. In this way, for longer channels two succeeding phases can be formed in the transport direction. The first phase can contain predominantly or only liquid components, the second phase can contain both liquid components and also particles.

The microstructure in the separating area can border one or more passage openings. These passage openings have a height which is less than the height of the transport channel. The passage openings can be for example from 0.5 to 2 microns high. When the blood plasma is separated from whole blood the red blood cells due to their deformability can penetrate into the separating area with a delay, while the white blood cells are too large for the passage opening. Several passage openings can be located entirely or partially next to one another. Furthermore several passage openings can be located in succession entirely or partially in a side stream. The width of the passage openings can decrease for example from 10 microns to 2 microns in the direction of the side stream. Likewise the height of the passage openings in the side stream can decrease.

The length of the separating area can be smaller than its weight, the length of the separating area extending in the direction of the side stream. For example, the length can be 0.5 mm and the width can be 5 mm. A separating device can have one or more separating areas which can be located in succession.

The microstructure in the separating area can be a ramp, a gap or stairs. The microstructure can comprise spaced columns or one or more crosspieces. The gap width can be constant in the direction of the side stream, or it can increase or decrease.

Furthermore, a separation device can have a collecting element which adjoins the separating area in the direction of the side stream. This collecting element can be made as a collecting chamber. Such a collecting chamber can have for example an area of 5 mm×5 mm at a height of 0.01 mm and a volume of 0.25 microliters. In this collecting element there can be reagents. These reagents can react with the liquid components which enter the collecting element for purposes of analysis. The collecting element can be connected to the environment via a removal and/or vent channel. The liquid contained in the collecting element can be removed from it by means of a pump or a syringe or the like. Via the vent channel the air contained in the separating area and in the collecting element can escape as soon as the liquid enters the separating area and the collecting element.

The separating device can have an inlet which lies upstream of the separating area, viewed in the direction of flow of the transport channel, and which is connected to the transport channel. The separating device can have an outlet which lies at the end of the transport channel, viewed in the transport direction.

Other microstructured elements can adjoin the separating area, the collecting element or the ventilation channel.

### BRIEF DESCRIPTION OF THE DRAWINGS

Embodiments for the separating devices as claimed in the invention are detailed using the drawings.

FIG. 1a shows an overhead view of a separating device as claimed in the invention, in a simple version;

FIG. 1b shows a section through the separating device as shown in FIG. 1a along the line Ib-Ib;

FIG. 1c shows a section through the separating device as shown in FIG. 1a along the line Ic-Ic;

FIG. 2 shows a carrier with a separating device as claimed in the invention;

FIG. 3a shows a separating device as claimed in the invention with notches in the area of the transition between the separating area and a collecting chamber;

FIG. 3b shows a section through the separating device as shown in FIG. 3a along the line IIIb-IIIb;

FIG. 4 shows a separating device with a zigzagging crosspiece as the microstructure;

FIG. 5a shows a separating device with columns in the separating area which can be used in addition as a support structure for a cover element;

FIG. 5b shows a section through the separating device as shown in FIG. 5a along the line Vb-Vb;

FIG. 6 shows a separating device with columns located offset to one another in the separating area;

FIG. 7 shows a separating device with columns in the separating area, the distances of the columns to one another decreasing in the direction of flow;

FIG. 8 shows a separating device with a toothed crosspiece and columns in the separating area;

FIG. 9a shows a separating device with a ramp in the separating area;

FIG. 9b shows a section through the separating device as shown in FIG. 9a along line Ixb-Ixb;

FIG. 10a shows a separating device with steps in the separating area;

FIG. 10b shows a section through the separating device as shown in FIG. 10a along line Xb-Xb;

FIG. 11 a shows a separating device with an annularly arranged transport channel, an annularly arranged separating area, and a collecting space which is located within the separating area; and

FIG. 11b shows a section through the separating device as shown in FIG. 11a along line XIb-XIb.

### DETAILED DESCRIPTION OF THE INVENTION

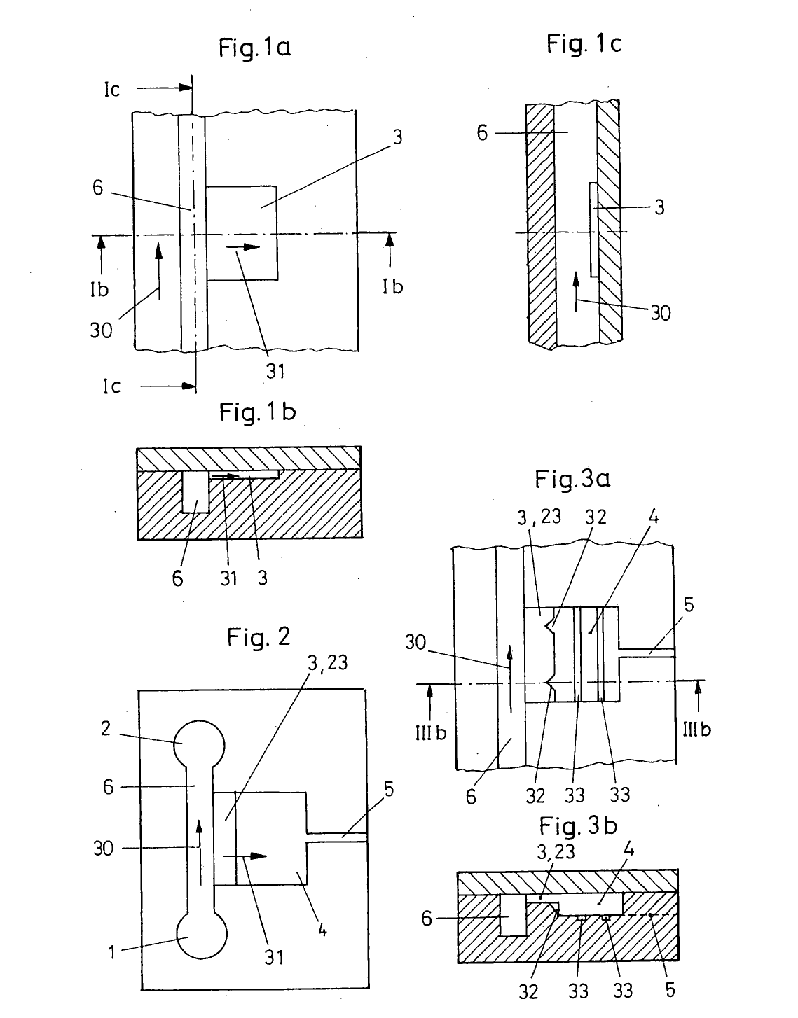

FIGS. 1a to 1c show a simplified separating device in which the operating principle of a separating device is explained. The separating devices shown in the figures and thus also the separating devices as shown in FIGS. 1a to 1c are designed such that with them, for example, blood plasma can be separated from whole blood. With the separating device, the blood plasma contained in the whole blood can be separated from the hematocrit contained in the blood.

The separating device, as shown in FIGS. 1a to 1c for this purpose has a transport channel 6 and a separating area 3, like the other separating devices shown in the figures. The supplied blood is transported in the transport channel 6 in the transport direction 30. The blood can be transported solely by capillary forces between the start and the end of the transport channel 6. Next to the transport channel 6 there is a separating area 3. In this separating area 3 the flow velocity of the hematocrit is slowed down relative to the flow velocity of the blood plasma such that in the transport direction 31 at the end of the separating area 3 the blood plasma which has been isolated from the hematocrit collects.

A microstructured separating device for separating liquid components from a particle-containing liquid has at least one transport channel for transport of the liquid in a given transport direction. At least one separating area at a branch point of the transport channel is adjoined by a side channel through which a partial flow of the liquid from the transport channel is diverted. A microstructure in the at least one separating area keeps larger particles of the liquid out of the separating area and the side channel slows down the transport of smaller particles in the separating area. The microstructures border one or more passage openings, the passage openings are smaller than the larger particles and larger than the smaller particles. The ratio of the length of the separating area to the length of the side channel is such that the partial flow free of larger or smaller particles fills the side channel before the smaller particles have reached the end of the separating area due to the slowing down of the smaller particles in the separating area. The side channel may be a collecting element adjoining the separating area in the transport direction The side channel may also be a removal channel or a removal and vent channel adjoining the collecting element.

Both the transport channel 6 and also the separating area 3 are provided as a recess in the surface of the carrier. The transport channel 6 has a greater depth than the separating area 3. The transition between the transport channel 6 and the separating area 3 is therefore formed by a shoulder. The recesses, i.e. the transport channel 6 and the separating area 3, can be covered with a cover which can consist for example of the same material as the carrier or of a foil or film.

The shoulder, the cover and the side walls of the separating area form the microstructure of the separating area 3 with a defined passage opening. This passage opening is dimensioned such that the larger cellular components cannot travel through the passage opening and are washed away from the blood flowing in the transport channel 6, and cannot close the passage opening of the separating area. These components are predominantly the white blood cells. The passage opening is advantageously dimensioned such that smaller cellular components can only pass through the passage opening when these smaller cellular components deform and adapt to the size of the passage opening. Within the separating area 3 the blood plasma and the smaller components of the blood are transported by capillary forces. The capillary forces in the separating area are lager than the capillary forces in the transport channel 6.

Another effect which arises in a separating device especially for separation of the blood plasma from the smaller cellular components of the blood is the “chromatographic effect”. The chromatographic effect results in that the blood plasma is transported more rapidly through the separating area 3 than cellular components, for example red blood cells which can penetrate into the separating area 3, but are moved along in the separating area 3 more slowly than the blood plasma. Before the cellular components can reach the collecting area at the end of the separating area 3, it is already completely filled with blood plasma. The red blood cells can no longer penetrate into the collecting area and travel into the blood plasma.

FIG. 2 shows a carrier with a separating device in which there are an inlet 1 and an outlet 2 which are interconnected via the transport channel 6. The transport channel 6 is adjoined by the separating area 3. The blood plasma which is to be separated flows through this separating area 3 in the direction 31. In the direction 31 the separating area 3 is adjoined by a collecting element which is made as a collecting chamber 4. This collecting chamber 4 is connected to the environment via a removal and vent channel 5.

A syringe or a pump can be connected to the end of the vent and removal channel in order to remove the separated blood plasma from the collecting chamber. The air which is contained in the collecting chamber 4 and in the separating area 3 and which is displaced when the blood plasma enters the collecting chamber 4 and the separating area 3 is removed via the removal and vent channel. In exactly the same way the collecting area and the collecting chamber can be vented through an opening in the cover.

The inlet 1, the outlet 2, the transport channel 6, the separating area 3, the collecting chamber 4 and the removal and vent channel 5 are provided as recesses in the carrier. The inlet, the transport channel 6 and the outlet 2 are made such that blood delivered into the inlet 1 is transported from the inlet 1 via the transport channel 6 to the outlet 2 by the capillary forces acting in the inlet 1, the transport channel 6 and the outlet 2.

In the separating area 3 capillary forces act which are greater than the capillary forces in the transport channel 6. In this way part of the blood flowing in the transport channel is branched off into the separating area 3. The bottom of the carrier in the separating area 3, the side walls of the recess and the cover on the carrier form a passage opening with a height which is less than the height of the transport channel 6. Since the height of the collecting chamber 4 is greater than the height of the passage opening of the separating area 3, the microstructure of the separating area 3 is made as a crosspiece 23. The height of the passage opening between the crosspiece 23 and the cover is dimensioned such that especially the larger cellular components of the blood cannot pass between the crosspiece 23 of the separating area 3 and the cover of the separating device. Only the blood plasma, and depending on the height of the passage opening, possibly the smaller cellular components of the blood, can be transported from the transport channel 6 into the collecting chamber 4 by the capillary forces acting in the separating area 3. The cellular components of the blood which collect upstream of the entry opening of the separating area 3 are not deposited, which could clog the separating area 3, but are transported by the blood which is flowing after out of the inlet in the transport direction 30 to the outlet 2, where blood with an increased concentration of hematocrit is optionally collected.

In the separating area 3, as a result of the “chromatographic effect”, the blood plasma is separated from the smaller cellular components which are still possibly contained in the liquid.

Various separating devices with a transport channel 6, a separating area 3 and a collecting chamber 4 as well as a removal and vent channel 5 are described using FIGS. 3a to 10b, as they can be used accordingly in a carrier as shown in FIG. 2 or in other carriers. The separating devices of FIGS. 3a to 10b differ from the separating device used in the carrier as shown in FIG. 2 essentially by the configuration of the separating area 3 or by the configuration of the collecting chamber 4.

In the separating device as shown in FIGS. 3a and 3b, in contrast to the separating area 3 as shown in FIG. 2, in the transition from the separating area 3 to the collecting chamber 4 there are two notches 32 in the side surface of the crosspiece. As is apparent from the sectional view of FIG. 3b, these notches connect the separating area 3 to the bottom of the collecting chamber 4. These notches overcome the capillary stop which may be formed by the sudden change of geometrical properties in the area of the transition from the separating area 3 to the collecting chamber 4. The blood plasma which flows via the separating area 3 is transported in the notches.

Another difference between the separating device as shown in FIG. 2 and the separating device as shown in FIGS. 3a and 3b is that in the separating device as shown in FIGS. 3a and 3b in the bottom of the collecting chamber 4 there are grooves 33 which lie transversely to the transport direction 3 1. These grooves make the approaching liquid front of blood plasma more uniform and regulate it. The grooves 33 first stop the liquid front until the entire area between the groove 33 and the separating area 3 is filled with blood plasma. The blood plasma which is flowing after forces the blood plasma away via the groove 33. The collecting chamber 4 is uniformly filled with blood plasma in this way. The air which is contained initially in the collecting chamber 4 is routed out of the collecting chamber 4 via the removal and vent channel 5, without the formation of air bubbles.

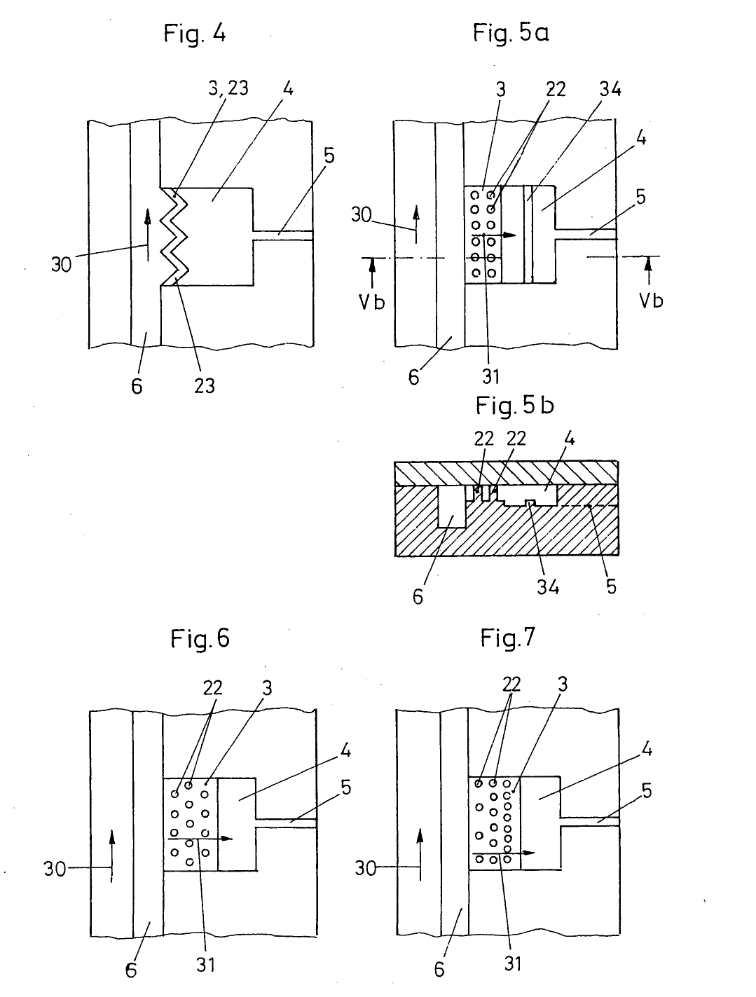

The embodiment shown in FIG. 4 for a separating device differs from the separating device as shown in FIG. 2 in that instead of a straight crosspiece 23 with edges which are parallel to the transport direction 30 a toothed crosspiece 23′ is used. The toothed shape of the crosspiece 23′ increases the contact area of the crosspiece 23′ and the effective contact area in the separating area 3.

In the separating devices used in FIGS. 5a to 7 there is a crosspiece in which columns 22 extend between the surface of the crosspiece and the bottom of the cover (not shown in FIG. 5a, FIG. 6 and FIG. 7). Because of the columns 22 the separating area 3 has not only a passage opening, but the separating area 3 is divided by the columns 22 into several passage openings.

The columns 22 are located in two rows with successive columns in the separating device as shown in FIGS. 5a and 5b. The passage openings which are bordered by the columns of the first row can have the same width as the passage openings which are bordered by the columns of the second row. The separating device as shown in FIGS. 5a and 5b in the collecting chamber 4 has a crosspiece 34 which lies transversely to the transport direction 31. The crosspiece 34 first dams up the liquid in front of it. As soon as the area in front of the crosspiece 34 is completely filled, the liquid overcomes the crosspiece 34 and penetrates into the area of the collecting chamber 4 which is downstream of the crosspiece 34. In a manner similar to that accomplished by the grooves 33, this results in that the blood plasma which penetrates into the collecting chamber 4 uniformly fills the collecting chamber 4 and the air contained in the collecting chamber 4 escapes through the vent and removal channel 5 without the formation of air bubbles in the collecting chamber 4.

In contrast to the separating device as shown in FIGS. 5a and 5b, in the separating device as shown in FIG. 6 the columns 22 are arranged offset behind one another in three rows, i.e. the columns of the second row are flush with the passage openings between the columns of the first row and the columns of the third row are flush with the passage openings between the columns of the second row. This offset arrangement of the columns 22 slows down the smaller cellular components which are entrained in the liquid by colliding with the columns, by which the blood plasma which is flowing faster has more time to fill the collecting chamber 4 before the first cellular component reaches the collecting chamber 4.

In the separating device as shown in FIG. 7 the passage openings between the columns of the first row have a greater width than the passage openings between the columns of the second row. The passage openings between the columns of the second row have a greater width than the passage openings between the columns of the third row. This microstructure has the advantage that cellular components which have possibly penetrated from the transport channel 6 into the separating area 3, depending on the size in the first, second or third row of the columns 22, are stopped without clogging the separating area.

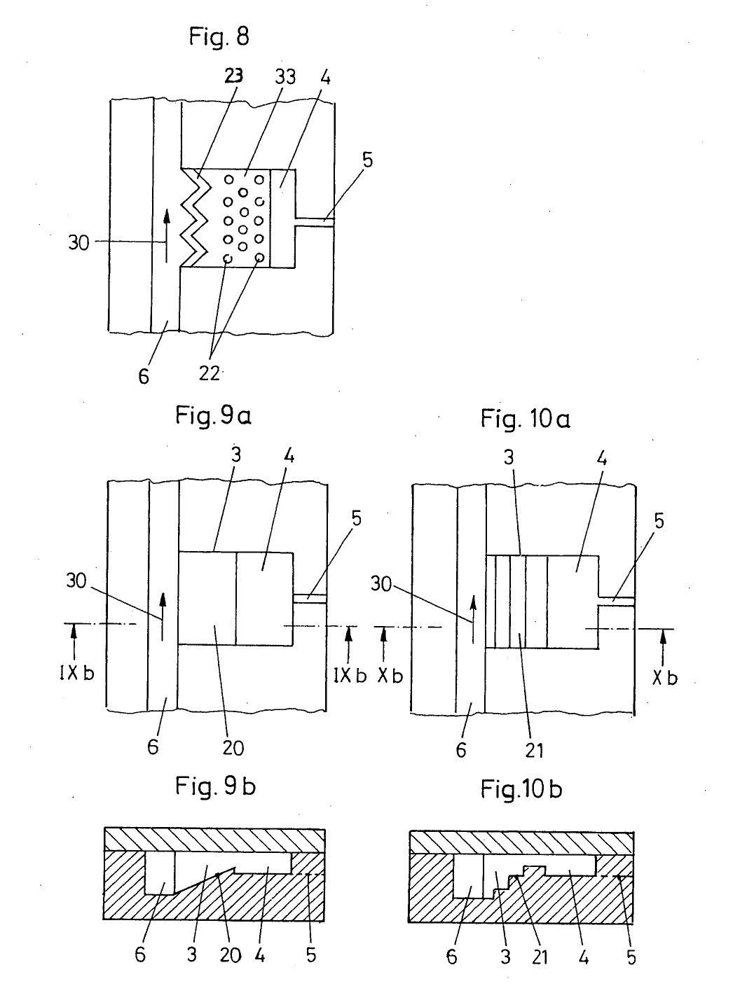

The separating device as shown in FIG. 8 as the microstructures has both a crosspiece 23 and also columns 22. The crosspiece 23 is located in the area of the separating area 3 bordering the transport channel 6 and extends in a zigzag next to the transport channel 6. Behind the crosspiece 23 staggered in three rows and set to a gap there are the columns 22.

The height of the passage opening in the area of the crosspiece 23 is made such that smaller cellular components of the blood, such as for example the red blood cells, can pass through the intermediate space between the crosspiece 23 and the cover, but these components are stopped by the columns 22.

FIGS. 9a and 9b shows a separating device in which the separating area 3 is formed by a ramp 20. This ramp 20 rises from the level of the bottom of the transport channel 6. The smallest cellular components cannot pass through the passage opening at the end of the ramp. The forward area of the ramp 20 which directly adjoins the transport channel 6 is continuously flushed by the blood flowing in the transport channel. The particles present in this area are washed away from the liquid flow in the transport channel 6.

The separating device as shown in FIGS. 10a and 10b has a separating area 3 with a microstructure which is formed by stairs 21. The stairs 21 gradually reduce the height between the stairs 21 and the cover. The smallest cellular components of the blood, i.e. especially the red blood cells, do not pass through the passage opening between the last stage and the cover, or only pass with a delay.

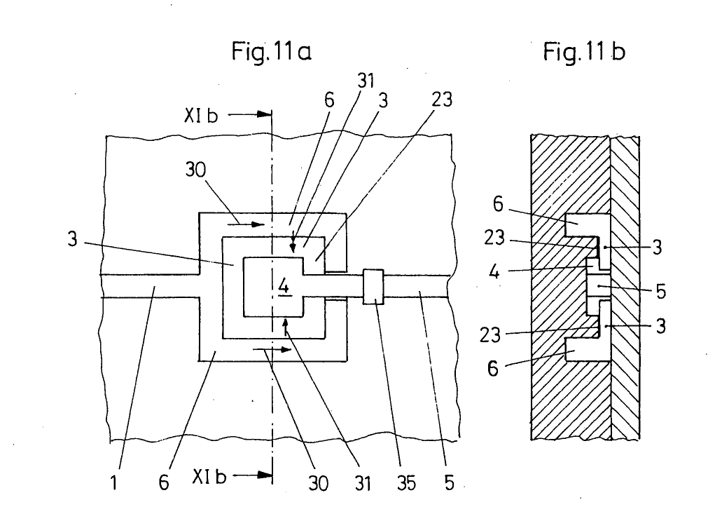

FIGS. 11a and 11b show another version of the separating device. This separating device as the inlet 1 has a channel which adjoins the transport channel 6 which is C-shaped in an overhead view. The transport channel 6 is connected in the area of the crosspiece which joins the two legs of the “C”. The transport channel 6 has two transport channel halves which are connected to the end of the inlet 1. The separating area 3 extends, likewise C-shaped in an overhead view, along the inner side of the two halves of the transport channel 6. The interior of this separating area 3 is the collecting chamber 4 which is connected to the removal and vent channel 5 which is routed through the open side of the separating area 3 which is C-shaped in an overhead view and of the transport channel 6 which is C-shaped in an overhead view. Both the inlet 1 and also the transport channel 6 or the transport channel halves are made such that the blood which has been delivered via the inlet into the separating device is transported by the capillary forces acting in the inlet 1 and the halves of the transport channel 6 from the end of the inlet 1 to the ends of the halves of the transport channel 6.

The ends of the transport channel halves are connected for example to an outlet which holds the excess blood from the transport channel halves.

The separating device 3 has a microstructure which is formed by a crosspiece 23 which extends between the transport channel halves 6 and the collecting chamber 4. Between the crosspiece 23 and the cover of the separating device as claimed in the invention which covers the channels 5, 6, the separating area 3 and the collecting chamber 4, a passage opening remains which is so high than the larger cellular components cannot penetrate through it. The crosspiece in the transport direction 31 has an extension which is dimensioned such that smaller cellular components, such as for example red blood cells, only reach the inner edge of the crosspiece 23 when the collecting chamber 4 is already completely filled with blood plasma. As soon as the collecting chamber 4 is completely filled, the red blood cells which are located in the separating area 3 cannot be transported into the collecting chamber 4 as a result of the stopping transport mechanisms, so that mixing of the blood plasma with the red blood cells is prevented.

In this version the removal and vent channel 5 forms a capillary stop 35 which can be overcome by applying an external pressure, for example by a syringe or by a pump, in order to remove the separated blood plasma from the collecting chamber.

What is claimed is:

1. A microstructured separating device for separating liquid components from a particle-containing liquid, comprising the following:
at least one transport channel for transport of the liquid in a given transport direction;
at least one separating area at a branch point of the transport channel which is adjoined by a side channel through which a partial flow of the liquid from the transport channel is diverted;
a microstructure in the at least one separating area which keeps larger particles of the liquid out of the separating area and the side channel and which slows down the transport of smaller particles in the separating area,
the microstructures border one or more passage openings
the passage openings are smaller than the larger particles and larger than the smaller particles,
the ratio of the length of the separating area to the length of the side channel is such that the partial flow free of larger or smaller particles fills the side channel before the first smaller particles has reached the end of the separating area due to the slowing down of the smaller particles in the separating area.

2. The microstructured separating device as claimed in claim 1, wherein the passage openings have a height which is less than the height of the transport channel.

3. The microstructured separating device as claimed in claim 1, wherein the height of the passage openings is 0.5 to 2 microns.

4. The microstructured separating device as claimed in claim 1, wherein the passage openings are located entirely or partially next to one another.

5. The microstructured separating device as claimed in claim 1, wherein the passage openings are located entirely or partially in succession in the transport direction.

6. The microstructured separating device as claimed in claim 5, wherein the width of the passage openings decreases in the transport direction.

7. The microstructured separating device as claimed in claim 6, wherein the height of the passage openings decreases in the transport direction.

8. The microstructured separating device as claimed in claim 1, wherein the separating area has one or more microstructures.

9. The microstructured separating device as claimed in claim 1, wherein the microstructure is a ramp.

10. The microstructured separating device as claimed in claim 1, wherein the microstructure is stairs.

11. The microstructured separating device as claimed in claim 1, wherein the microstructure comprises columns which are spaced apart from one another.

12. The microstructured separating device as claimed in claim 1, wherein the microstructure comprises one or more crosspieces.

13. The microstructured separating device as claimed in claim 1, wherein the side channel comprises a collecting element adjoining the separating area in the transport direction.

14. The microstructured separating device as claimed in claim 13, wherein the collecting element is made as a collecting chamber.

15. The microstructured separating device as claimed in claim 13, wherein the collecting element contains reagents.

16. The microstructured separating device as claimed in claim 13, wherein the side channel comprises a removal channel or a removal and vent channel adjoining the collecting element.

17. The microstructured separating device as claimed in claim 16, wherein a removal and/or vent channel adjoins the separating area.

18. The microstructured separating device as claimed in claim 1, wherein the separating device has an inlet.

19. The microstructured separating device as claimed in claim 1, wherein the separating device has an outlet which adjoins the end of the transport channel in the transport direction.

20. A microfluidic process for separating liquid components from a particle-containing liquid, characterized by the following:
the liquid is transported in a transport channel;
part of the liquid is branched off out of the transport channel via the separating area;
larger particles being retained upon entry into the separating area and being washed away from the liquid flowing in the transport channel and
smaller particles being slowed down upon entry into the separating area or during transport into the separating area.
